(19) United States
(12) Patent Application Publication
(10) Pub. No.: US 2021/0223058 A1
(43) Pub. Date: Jul. 22, 2021

(54) DISPLAY CONTROL DEVICE AND NON-TRANSITORY COMPUTER-READABLE STORAGE MEDIUM FOR THE SAME

(71) Applicant: DENSO CORPORATION, Kariya-city (JP)

(72) Inventors: Satoshi HORIHATA, Kariya-city (JP); Yusuke KONDO, Kariya-city (JP); Takeshi HATO, Kariya-city (JP); Kazuki KOJIMA, Kariya-city (JP)

(21) Appl. No.: 17/222,259

(22) Filed: Apr. 5, 2021

Related U.S. Application Data
(63) Continuation of application No. PCT/JP2019/046318, filed on Nov. 27, 2019.

(30) Foreign Application Priority Data
Dec. 14, 2018 (JP) 2018234566
Oct. 29, 2019 (JP) 2019-196468

(51) Int. Cl. G01C 21/36

(52) U.S. Cl. CPC G01C 21/365; G01C 21/3635; G01C 21/367

(57) ABSTRACT

A virtual image is superimposed on a foreground scenery of an occupant of a vehicle. A position of the vehicle is acquired. High-precision map information or low-precision map information with lower accuracy than the high-precision map information, corresponding to the position is acquired. The virtual image is generated in a first display mode based on the high-precision map information when the high-precision map information can be acquired. The virtual image is generated in a second display mode different from the first display mode based on the low-precision map information when the high-precision map information cannot be acquired.

### CROSS REFERENCE TO RELATED APPLICATION

The present application is a continuation application of International patent Application No. PCT/JP2019/046318 filed on Nov. 27, 2019, which designated the U.S. and claims the benefit of priority from Japanese Patent Applications No. 2018-234566 filed on Dec. 14, 2018, and No. 2019-196468 filed on Oct. 29, 2019. The entire disclosures of all of the above applications are incorporated herein by reference.

### TECHNICAL FIELD

The present disclosure relates to a display control device for displaying a virtual image and a non-transitory computer-readable storage medium for the same.

### BACKGROUND

A conceivable technique relates to a head-up display device that controls displaying a virtual image using map information. This device displays the travelling road shape in front of the vehicle as a virtual image based on the current position of the vehicle and the map information.

### SUMMARY

According to an example, a virtual image is superimposed on a foreground scenery of an occupant of a vehicle. A position of the vehicle is acquired. High-precision map information or low-precision map information with lower accuracy than the high-precision map information, corresponding to the position is acquired. The virtual image is generated in a first display mode based on the high-precision map information when the high-precision map information can be acquired. The virtual image is generated in a second display mode different from the first display mode based on the low-precision map information when the high-precision map information cannot be acquired.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of a vehicle system including an HCU according to the first embodiment;

FIG. 2 is a diagram showing an example in which an HUD is mounted on a vehicle;

FIG. 3 is a block diagram showing a schematic configuration of an HCU;

FIG. 4 is a diagram showing an example of superimposed display;

FIG. 5 is a diagram showing an example of superimposed display;

FIG. 6 is a diagram showing an example of non-superimposed display;

FIG. 7 is a diagram showing a state of display deviation due to superimposed display of a modified example;

FIG. 8 is a conceptual diagram showing an example of display switching timing;

FIG. 9 is a flowchart showing an example of a process executed by the HCU;

FIG. 10 is a schematic view of a vehicle system including an HCU according to the second embodiment;

FIG. 11 is a block diagram showing a schematic configuration of the HCU of the second embodiment;

FIG. 12 is a diagram that visualizes and shows an example of a display layout simulation executed by a display generation unit in the third embodiment;

FIG. 13 is a diagram showing an example of virtual image display in the first display mode in the third embodiment;

FIG. 14 is a diagram that visualizes and shows an example of a display layout simulation executed by a display generation unit in the third embodiment;

FIG. 15 is a diagram showing an example of virtual image display in the second display mode in the third embodiment;

FIG. 16 is a diagram showing an example of virtual image display in the second display mode in the third embodiment;

FIG. 17 is a flowchart showing an example of a process executed by the HCU;

FIG. 18 is a diagram showing an example of virtual image display in the first display mode in another embodiment; and

FIG. 19 is a diagram showing an example of virtual image display in the second display mode in another embodiment.

### DETAILED DESCRIPTION

Here, the map information includes high-precision map information and low-precision map information that is relatively less accurate than the high-precision map information. The conceivable technique does not provide that such map information is effectively used.

In view of the above point, a display control device, a display control program, and a non-transitory tangible computer-readable storage medium are provided for effectively using map information.

According to an example, a display control device used in a vehicle and controlling the display of a virtual image superimposed on the foreground of an occupant includes: a vehicle position acquisition unit that acquires the position of the vehicle; a map information acquisition unit that acquires high-precision map information or low-precision map information less accurate than the high-precision map information with respect to the position; and a display generation unit that generates the virtual image based on the high-precision map information in a first display mode when the high-precision map information is acquired, and generates the virtual image based on the low-precision map information in a second display mode different from the first display mode when the high-precision map information is not acquired.

According to an example, a display control program used in a vehicle and controlling the display of a virtual image superimposed on the foreground of an occupant functions at least one processor as: a vehicle position acquisition unit that acquires the position of the vehicle; a map information acquisition unit that acquires high-precision map information or low-precision map information less accurate than the high-precision map information with respect to the position; and a display generation unit that generates the virtual image based on the high-precision map information in a first display mode when the high-precision map information is acquired, and generates the virtual image based on the low-precision map information in a second display mode different from the first display mode when the high-precision map information is not acquired.

According to an example, a non-transitory tangible computer-readable storage medium includes an instruction performed by a computer. The instruction is used for a vehicle and controls the display of a virtual image superimposed on the foreground of an occupant. The instruction includes: acquiring the position of the vehicle; acquiring high-precision map information or low-precision map information less accurate than the high-precision map information with respect to the position; and generating the virtual image based on the high-precision map information in a first display mode when the high-precision map information is acquired, and generating the virtual image based on the low-precision map information in a second display mode different from the first display mode when the high-precision map information is not acquired.

According to an example, a display control device used in a vehicle and controlling the display of a virtual image superimposed on the foreground of an occupant includes at least one processor. The at least one processor executes: acquiring the position of the vehicle; acquiring high-precision map information or low-precision map information less accurate than the high-precision map information with respect to the position; and generating the virtual image based on the high-precision map information in a first display mode when the high-precision map information is acquired, and generating the virtual image based on the low-precision map information in a second display mode different from the first display mode when the high-precision map information is not acquired.

According to these examples, the high-precision map information is used to generate the virtual image when the high-precision map information can be acquired, and the low-precision map information is used to generate the virtual image when the high-precision map information can not be acquired. As described above, it is possible to display a virtual image by properly using the high-precision map information and the low-precision map information. Accordingly, a display control device, a display control program, and a non-transitory tangible computer-readable storage medium are provided for effectively using map information.

### First Embodiment

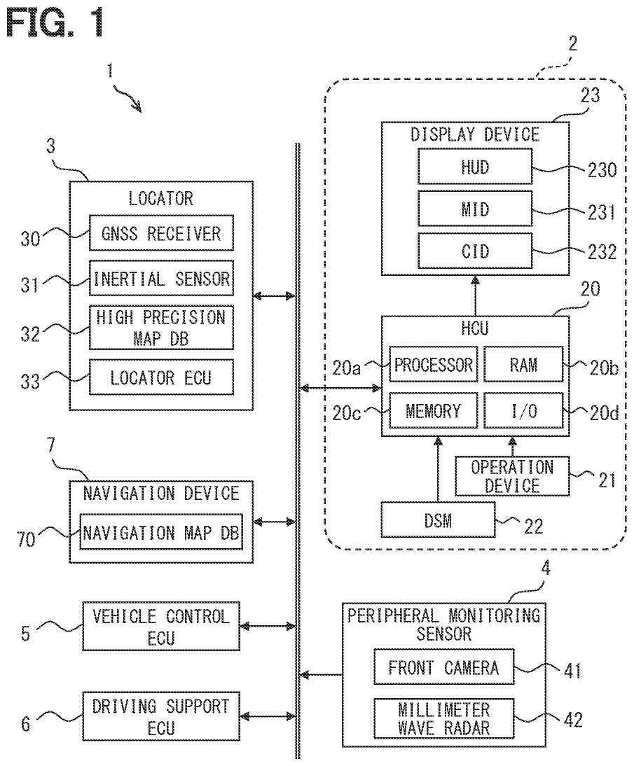

A display control device according to a first embodiment will be described with reference to FIGS. 1 to 9. The display control device of the first embodiment is provided as an HCU (Human Machine Interface Control Unit) 20 used in the vehicle system 1. The vehicle system 1 is used in a vehicle A traveling on a road such as an automobile. As an example, the vehicle system 1 includes an HMI (Human Machine Interface) system 2, a locator 3, a peripheral monitoring sensor 4, a driving support ECU 6, and a navigation device 7, as shown in FIG. 1. The HMI system 2, the locator 3, the peripheral monitoring sensor 4, the driving support ECU 6, and the navigation device 7 are connected to, for example, an in-vehicle LAN.

As shown in FIG. 1, the locator 3 includes a GNSS (Global Navigation Satellite System) receiver 30, an inertial sensor 31, a high-precision map database (hereinafter, high-precision map DB) 32, and a locator ECU 33. The GNSS receiver 30 receives positioning signals from multiple artificial satellites. The inertial sensor 31 includes a gyro sensor and an acceleration sensor, for example.

The high-precision map DB 32 is a non-volatile memory and stores high-precision map data (i.e., high-precision map information). The high-precision map DB 32 is provided by the memory device of the locator ECU 33 described later. The high-precision map data includes information on roads, information on lane markings such as white lines and road markings, information on structures, and the like. The information about roads includes shape information such as position information for each point, curve curvature and slope, and connection relationship with other roads. The information on lane markings and road markings includes, for example, type information of lane markings and road markings, location information, and three-dimensional shape information. The information about the structure includes, for example, type information, position information, and shape information of each structure. Here, the structures are road signs, traffic lights, street lights, tunnels, overpasses, buildings facing roads, and the like.

The high-precision map data has the above-mentioned various position information and shape information as point group data, vector data, and the like of feature points represented by three-dimensional coordinates. That is, it can be said that the high-precision map data is a three-dimensional map that includes altitude in addition to latitude and longitude with respect to position information. High-precision map data has these position information with a relatively small error (for example, on the order of centimeters). High-precision map data is highly accurate map data in that it has position information based on three-dimensional coordinates including height information, and it is also highly accurate map data in that the error in the position information is relatively small.

High-precision map data is created based on the information collected by surveying vehicles traveling on actual roads. Therefore, the high-precision map data is created for the area where the information is collected, and is out of the range for the area where the information is not collected. In general, the high-precision map data is currently maintained with relatively wide coverage for expressways and motorways, and with relatively narrow coverage for general roads.

The locator ECU 33 mainly includes a microcomputer including a processor, a RAM, a memory device, I/O, and a bus for connecting them. The locator ECU 33 is connected to the GNSS receiver 30, the inertial sensor 31, and the in-vehicle LAN. The locator ECU 33 sequentially measures a vehicle position of a subject vehicle A by combining the positioning signals received by the GNSS receiver 30 and the measurement results of the inertial sensor 31.

The locator ECU 33 may use the travelling distance and the like obtained from the detection results sequentially output from the vehicle speed sensor mounted on the own vehicle for positioning the position of the own vehicle. Further, the locator ECU 33 may specify the position of the own vehicle by using the high-precision map data described later and the detection result by the peripheral monitoring sensor 4 such as LIDAR that detects the point group of the feature points of the road shape and the structure. The locator ECU 33 outputs the vehicle position information to the in-vehicle LAN.

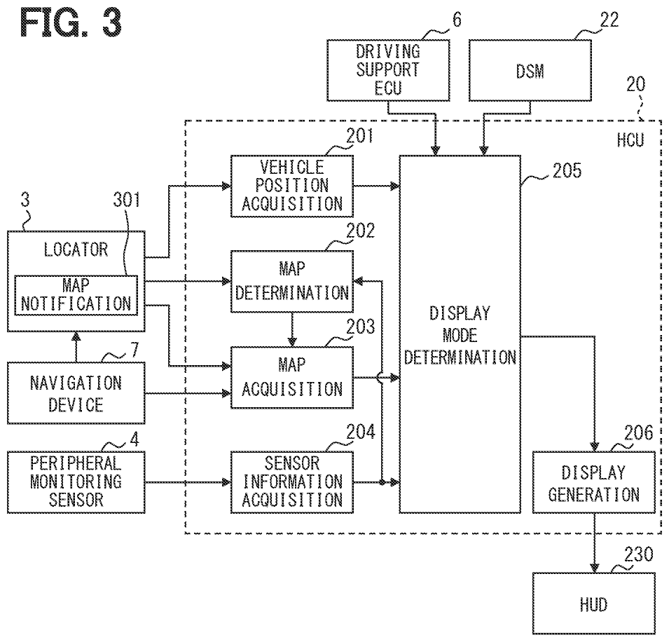

Further, as shown in FIG. 3, the locator ECU 33 has a map notification unit 301 as a functional block. Based on the measured vehicle position information and the high-precision map data of the high-precision map DB 32, the map notification unit 301 determines whether the high-precision map data includes information about the current vehicle position of the vehicle A, which is information corresponding to the vehicle position. The map notification unit 301 calculates, for example, the traveling locus of the vehicle A based on the position information of the own vehicle, and executes a so-called map matching process of superimposing the traveling locus of the vehicle A on the road shape of the high-precision map data. The map notification unit 301 determines whether or not the current position of the own vehicle is included in the high-precision map data from the result of this map matching process. Alternatively, the map notification unit 301 may use not only the two-dimensional position information (for example, longitude and latitude) of the vehicle A but also the height information based on the own vehicle position information, and determine whether the information about the current own vehicle position is included in the high precision map data. By the map matching process or the process using the height information described above, the map notification unit 301 can determine which road the vehicle A is running, even when the roads having different heights (for example, an elevated road and a ground road) are disposed close to each other. As a result, the map notification unit 301 can improve the determination accuracy. Based on the determination result, the map notification unit 301 outputs notification information indicating that the information about the position of the own vehicle is included or not included in the high-precision map data to the HCU 20.

The peripheral monitoring sensor 4 is an autonomous sensor that monitors the surrounding environment of the subject vehicle. The peripheral monitoring sensor 4 detects objects around the vehicle such as moving dynamic targets such as pedestrians, animals other than humans, vehicles other than the own vehicle, and road markings such as falling objects, guardrails, curbs, traveling lane markings, and stationary static targets such as trees and the like.

For example, the peripheral monitor sensor 4 is a peripheral monitor camera that captures a predetermined range around the subject vehicle, and a scanning wave sensor that transmits a scanning wave to a predetermined range around the subject vehicle such as a millimeter wave radar, a sonar, or a lidar.

The peripheral monitoring camera sequentially outputs the captured images to be sequentially captured as sensing information to the in-vehicle LAN. The scanning wave sensor sequentially outputs the scanning result based on the received signal obtained when the reflected wave reflected by the object is received to the in-vehicle LAN as sensing information. The peripheral monitoring sensor 4 of the first embodiment includes at least a front camera 41 whose imaging range is a predetermined range in front of the own vehicle. The front camera 41 is arranged, for example, on the rearview mirror of the own vehicle, the upper surface of the instrument panel, or the like.

The driving support ECU 6 executes an automatic driving function that substitutes the driving operation by the occupant. The driving support ECU 6 recognizes the driving environment of the own vehicle based on the vehicle position and map data of the own vehicle acquired from the locator 3 and the sensing information by the peripheral monitoring sensor 4.

As an example of the automatic driving function executed by the driving support ECU 6, the ACC (Adaptive Cruise Control) function controls the traveling speed of the own vehicle so as to maintain the target inter-vehicle distance from the preceding vehicle by adjusting the driving force and the braking force. In addition, there is an AEB (Autonomous Emergency Breaking) function that forcibly decelerates the own vehicle by generating a braking force based on the sensing information ahead. The driving support ECU 6 may have other functions as a function of autonomous driving.

The navigation device 7 includes a navigation map database (hereinafter, navigation map DB) 70 that stores navigation map data. The navigation device 7 searches for a route that satisfies conditions such as time priority and distance priority to the set destination, and provides route guidance according to the searched route. The navigation device 7 outputs the searched route as scheduled route information to the in-vehicle LAN.

The navigation map DB 70 is a non-volatile memory and stores navigation map data such as link data, node data, and road shape. Navigation map data is maintained in a relatively wider area than high-precision map data. The link data includes various data such as a link ID that identifies the link, a link length that indicates the length of the link, a link direction, a link travel time, node coordinates between the start and end of the link, and road attributes. The node data includes a various pieces of data such as a node ID in which a unique number is assigned to each node on a map, node coordinates, a node name, a node type, a connection link ID in which a link ID of a link connected to the node is described, an intersection type, and the like.

The navigation map data has node coordinates as two-dimensional position coordinate information. That is, it can be said that the navigation map data is a two-dimensional map including the latitude and longitude with respect to the position information. Navigation map data is map data with relatively lower accuracy than high-precision map data such that the navigation map data does not have height information with respect to position information, and the navigation map data is also less accurate in that the error in position information is relatively large. The navigation map data is an example of low-precision map information.

The HMI system 2 includes an operation device 21, a display device 23, and an HCU 20, and receives input operations from an occupant who is a user of the own vehicle and presents information to the occupant of the own vehicle. The operation device 21 is a group of switches operated by the occupants of the own vehicle. The operation device 21 is used to perform various settings. For example, the operation device 21 may be configured by a steering switch or the like arranged in a spoke portion of a steering wheel of the host vehicle.

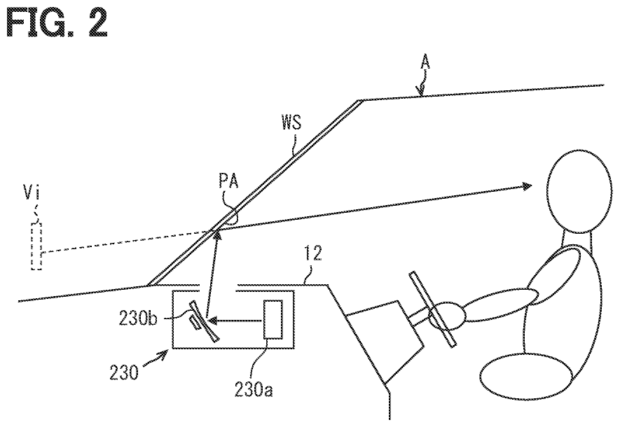

The display device 23 includes, for example, a head-up display (hereinafter referred to as HUD) 230, a multi-information display (MID) 231 provided on the meter, and a center information display (CID) 232. As shown in FIG. 2, the HUD 230 is arranged on an instrument panel 12 of the host vehicle. The HUD 230 forms a display image based on the image data output from the HCU 20 using, for example, a liquid crystal type or scanning type projector 230a. On the display screen of the CID 232, the navigation map data, the route information toward the destination, and the like are displayed by the navigation device 7.

The HUD 230 projects the display image formed by the projector 230a onto the projection region PA defined by the front windshield WS as a projection member through an optical system 230b such as a concave mirror. The projection area PA is located in front of the driver's seat. A light beam of the display image reflected by the front windshield WS to an inside of a vehicle compartment is perceived by the passenger seated in the driver's seat. In addition, a light beam from the front scenery as a foreground landscape existing in front of the host vehicle, which has passed through the front windshield WS made of light transparent glass, is also perceived by the passenger seated in the driver's seat. As a result, the occupant can visually recognize the virtual image Vi of the display image formed in front of the front windshield WS by superimposing it on a part of the foreground scenery.

As described above, the HUD 230 superimposes and displays the virtual image Vi on the foreground of the vehicle A. The HUD 230 superimposes the virtual image Vi on a specific superimposing object in the foreground, and realizes a so-called AR (Augmented Reality) display. In addition, the HUD 230 realizes a non-AR display in which the virtual image Vi is not superposed on a specific superimposing target but is simply superposed on the foreground. The projection member on which the HUD 230 projects the display image may not be limited to the front windshield WS, and may be a translucent combiner. The HCU 20 mainly includes a microcomputer including a processor 20a, a RAM 20b, a memory device 20c, an I/O 20d, and a bus for connecting them, and is connected to the HUD 230 and an in-vehicle LAN. The HCU 20 controls the display by the HUD 230 by executing the display control program stored in the memory device 20c. The HCU 20 is an example of a display control device, and the processor 20a is an example of a processing unit. The memory device 20c is a non-transitory tangible storage medium that non-temporarily stores a computer readable program and data. The non-transitory tangible storage medium is realized by a semiconductor memory, a magnetic disc, or the like.

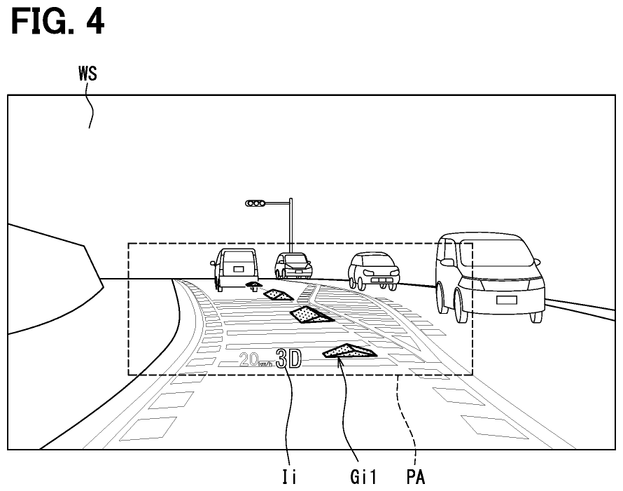

The HCU 20 generates an image of the content to be displayed as a virtual image Vi on the HUD 230 and outputs the image to the HUD 230. As an example of the virtual image Vi, the HCU 20 generates a route guidance image that guides the occupant on the planned travel route of the vehicle A, as shown in FIGS. 4 to 6.

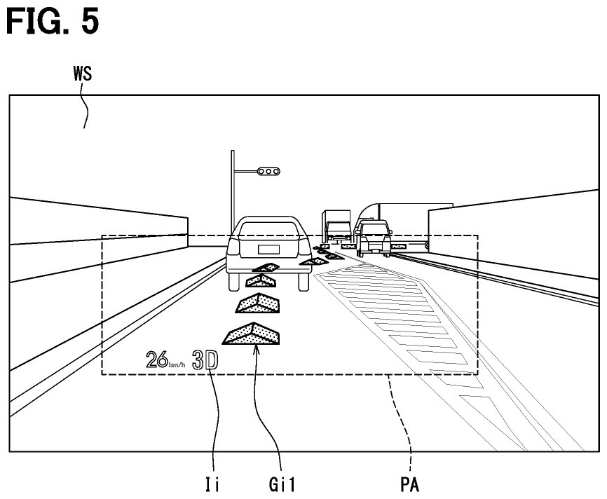

The HCU 20 generates an AR guide image Gil to be superimposed on the road surface as shown in FIGS. 4 and 5. The AR guide image Gil is generated, for example, in a three-dimensional display mode (hereinafter, 3D display mode) in which the AR guide image Gil is continuously arranged on the road surface along the planned travel route. FIG. 4 is an example in which the AR guide image Gil is superimposed and displayed on a sloped road. FIG. 5 shows an example in which the AR guide image Gil is superimposed and displayed along the shape of the road where the number of lanes is increasing toward the travelling direction.

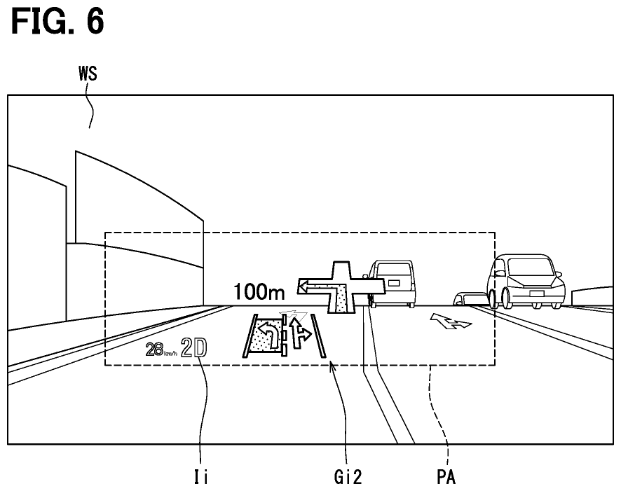

Alternatively, the HCU 20 may generate a non-AR guide image Gi2 simply displayed in the foreground as a route guide image as shown in FIG. 6. The non-AR guidance image Gi2 is a two-dimensional display mode (hereinafter, 2D display mode) which is fixed to the front windshield WS, such as an image highlighting the lane to be driven and an image of an intersection showing a traveling route. That is, the non-AR guide image Gi2 is a virtual image Vi that is not superimposed on a specific superimposed object in the foreground but is simply superimposed on the foreground. The three-dimensional display mode is an example of the first display mode, and the two-dimensional display mode is an example of the second display mode.

The HCU 20 has a vehicle position acquisition unit 201, a map determination unit 202, a map information acquisition unit 203, a sensor information acquisition unit 204, and a display mode determination unit 205 and a display generation unit 206 as functional blocks related to the generation of the AR guide image Gil and the non-AR guide image Gil. The vehicle position acquisition unit 201 acquires the own vehicle position information from the locator 3. The vehicle position acquisition unit 201 is an example of a vehicle position acquisition unit.

The map determination unit 202 determines whether to acquire high-precision map data or navigation map data as the map information used for generating the virtual image Vi based on the notification information or the like acquired from the locator 3.

The map determination unit 202 determines whether or not high-precision map data can be acquired. The map determination unit 202 determines that the high-precision map data can be acquired when the current position of the vehicle A is included in the high-precision map data. The map determination unit 202 performs this determination process based on the notification information output from the locator ECU 33. The position of the own vehicle used in the determination process here may include an area around the vehicle A on which the virtual image Vi can be superimposed. Further, the map determination unit 202 determines whether or not it is possible to acquire high-precision map data by itself based on the own vehicle position information acquired from the locator 3 and the high-precision map data, regardless of the notification information from the locator 3. The map determination unit 202 may continuously perform the above-mentioned determination process during traveling, or may intermittently execute the determination processing for each predetermined traveling section.

Further, the map determination unit 202 determines whether or not the high-precision map data includes information about the future traveling section GS of the vehicle A (in the section determination process). The future travel section GS is, for example, the most recent travel section of the planned travel route of the vehicle A, for which a route guidance image needs to be displayed. The display section in which the route guidance image needs to be displayed is, for example, a section including a point where a plurality of roads are connected such as an intersection, a section in which a lane change is required, and the like.

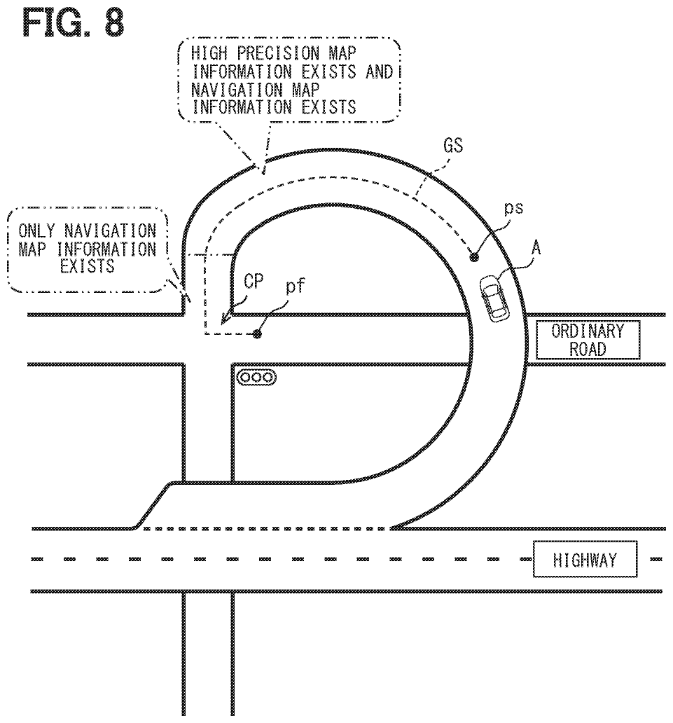

For example, the map determination unit 202 determines whether or not the entire range of the future travel section GS as shown in FIG. 8 is included in the high-precision map data. FIG. 8 shows a situation in which vehicle A tries to enter a general road from a highway through a ramp way. In FIG. 8, it is assumed that the vehicle A turns left at the intersection CP where the ramp way and the general road are connected.

The road shown in FIG. 8 is divided into an area where both high-precision map data and navigation map data are maintained and an area where only navigation map data is maintained, with the two-point chain line shown on the ramp way as the boundary line. Therefore, in the future traveling section GS, the section from the starting point ps (for example, a point being 300 meters before the intersection CP) where the route guidance is started to the boundary line is included in the high-precision map data. On the other hand, the section from the boundary line to the end point pf (for example, the exit point of the intersection) at which the route guidance ends is not included in the high-precision map data, but is included only in the navigation map data. In this case, the map determination unit 202 determines that the high-precision map data does not include information about the future traveling section GS of the vehicle A.

The map determination unit 202 executes this section determination process based on, for example, the planning route information provided by the navigation device 7 and the high-precision map data provided by the locator 3. The map determination unit 202 executes this section determination process at the timing when the vehicle A reaches or approaches the start point ps. Alternatively, the map determination unit 202 may be configured to acquire the determination result of the above-mentioned section determination process performed by the locator ECU 33.

In addition, the map determination unit 202 determines whether or not a shape condition that does not require the generation of the AR guide image Gil is satisfied with respect to the road shape on which the vehicle A travels, that is, whether or not a shape condition that stops the generation of the AR guide image Gil is satisfied (in the shape determination process). The shape condition is satisfied, for example, when the road shape is evaluated in the route guidance that the non-AR guidance image Gi2 can provide to accurately transmit the planned travel route to the occupants. Then, when it is evaluated that the occupant can misidentify the planned travel route when the non-AR guide image Gi2 is displayed instead of the AR guide image Gil, the shape condition is not satisfied. Here, the road shape is the number of lanes provided on the road, the slope and curvature, the connection relationship with other roads, and the like. For example, when the section where the route guidance is performed includes one lane, the lane of the destination is uniquely determined, so that the planned travel route can be accurately provided by the non-AR guidance image Gi2, and the shape condition is satisfied. In addition, if there is no other intersection between the intersection where the right/left turn guidance is performed and the vehicle A, the intersection where the right/left turn is to be performed is uniquely determined, so that the non-AR guidance image Gi2 accurately provides the planned travel route, and the shape condition is satisfied. Further, when the road is a flat road with substantially no slope, it is possible to see the destination direction of the vehicle A, so that the planned travel route can be accurately provided by the non-AR guide image Gi2, and the shape condition can be establish. The establishment of the shape condition may be determined by a combination of the plurality of cases described above, for example, when the road is a flat road and has only one lane.

The map determination unit 202 determines whether or not the shape condition is satisfied based on the high-precision map data provided by the locator 3, the detection information of the peripheral monitoring sensor 4, and the like. Alternatively, the map determination unit 202 may be configured to acquire the determination result of the above-mentioned shape determination process performed by the locator ECU 33.

The map determination unit 202 determines that the high-precision map data is acquired when the high-precision map data can be acquired at the current position of the own vehicle. Here, the map determination unit 202 determines that the navigation map data is acquired even if the high-precision map data at the current position of the own vehicle is available when the high-precision map data does not include information about the future traveling section GS or when the shape condition is satisfied.

The map information acquisition unit 203 acquires either high-precision map data or navigation map data based on the determination result in the map determination unit 202. The map information acquisition unit 203 acquires the high-precision map data when it is determined that the high-precision map data can be available. The map information acquisition unit 203 acquires navigation map data instead of high-precision map data when it is determined that high-precision map data cannot be acquired.

Here, when it is determined that the information regarding the guide point is not included in the high-precision map data, the map information acquisition unit 203 acquires the navigation map data even if the high-precision map data is available. In addition, the map information acquisition unit 203 acquires the navigation map data when it is determined that the shape condition is satisfied, even if it is determined that the high-precision map data can be acquired. The map information acquisition unit 203 sequentially outputs the acquired map information to the display mode determination unit 205.

The sensor information acquisition unit 204 acquires detection information regarding the detection object in front of the vehicle A. The detection information includes the height information of the road surface on which the AR guide image Gil is superimposed, or the height information of the detected object from which the height information can be estimated. The detected objects include road markings such as stop lines, central markings at intersections, and lane markings, and road installations such as road signs, curbs, and traffic lights. The detection information is information for correcting the superposed position of the navigation map data or the AR guide image Gil when the AR guide image Gil is generated using the navigation map data. The detection information may include information on the shape of the traveling road, information on the number of lanes on the traveling road, information on the lane in which the vehicle A is currently traveling, and the like. The sensor information acquisition unit 204 attempts to acquire the detection information, and when the detection information can be acquired, sequentially outputs the detection information to the display mode determination unit 205.

The display mode determination unit 205 generates the route guidance image in either the three-dimensional display mode or the two-dimensional display mode, that is, determines which the display generation unit 206 displays either the AR guide image Gil or the non-AR guide image Gi2 as the route guide image.

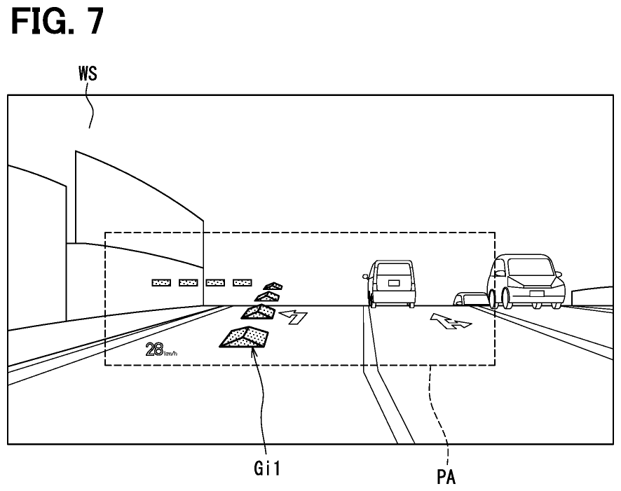

In the HUD 230, when the AR guide image Gil is to be displayed based on the navigation map data, the AR guide image Gil may be displayed as if the image Gil floats on the road surface as shown in the modified example shown in FIG. 7, or the image Gli may be displayed as if the image Gil is embedded in the road surface. Such a shift in the superposed position means that the navigation map data has a particularly low accuracy of height information as compared with the high-precision map data, or the navigation map data does not have height information so that the guide image Gil cannot be generated by reflecting the slope shape of the road. In order to suppress the generation of the AR guide image Gil whose superposition position is deviated, the display mode determination unit 205 selects one of the AR guide image Gil and the non-AR guide image Gi2 to generate the route guide image based on the availability of high-precision map data.

When the high-precision map data is acquired by the map information acquisition unit 203, the display mode determination unit 205 determines the display mode of the route guidance image to the three-dimensional display mode. When the map information acquisition unit 203 cannot acquire the high-precision map data, the display mode determination unit 205 determines the display mode of the route guidance image to be a two-dimensional display mode. Here, even if the map information acquisition unit 203 cannot acquire the high-precision map data, when the display mode determination unit 205 can acquire the detection information by the sensor information acquisition unit 204, the display mode of the route guidance image is determined to be the three-dimensional display mode. The display mode determination unit 205 outputs the determined display mode to the display generation unit 206.

The display generation unit 206 generates a route guidance image in the display mode determined by the display mode determination unit 205 based on the various acquired information. When the display mode is determined to be the three-dimensional display mode, the display generation unit 206 determines the three-dimensional position coordinates of the road surface on which the AR guide image Gil is superimposed based on the information of the three-dimensional position coordinates of the high-precision map data. The display generation unit 206 specifies a three-dimensional position (i.e., the relative position) of the road surface relative to the vehicle A based on the position coordinates of the road surface and the position coordinates of the own vehicle. In addition, the display generation unit 206 calculates or acquires the slope information of the road surface based on the high-precision map data. The display generation unit 206 calculates the gradient information by, for example, a geometric calculation using the position coordinates of two points defining a slope. Alternatively, the display generation unit 206 may calculate the gradient information based on the three-dimensional shape information of the lane marking. Alternatively, the display generation unit 206 may estimate the gradient information based on the information that can estimate the gradient information among the information included in the high-precision map data. The display generation unit 206 calculates the projection position and the projection shape of the AR guidance image Gil by geometric calculation based on the positional relationship between the specified relative position, the viewpoint position of the occupant obtained from the DSM 22, and the position of the projection area PA, and the slope of the road surface at the relative position, and the like. The display generation unit 206 generates an AR guide image Gil based on the calculation result, outputs data to the HUD 230, and displays the AR guide image Gil as a virtual image Vi.

Further, when the three-dimensional display mode is determined based on the detection information being acquired by the sensor information acquisition unit 204, the display generation unit 206 combines the two-dimensional position coordinates of the navigation map and the peripheral information to generate the AR guide image Gil. For example, the display generation unit 206 specifies the three-dimensional position coordinates of the road surface on which the AR guide image Gil is superimposed from the height information acquired or estimated from the detection information and the two-dimensional position coordinates of the navigation map. The display generation unit 206 calculates the projected position and the projected shape of the AR guide image Gil by using the specified position coordinates in the same manner as when using the high-precision map data. When the detection information includes the shape information of the driving road, the number of lanes information of the driving road, the lane information in which the vehicle A is currently traveling, and the like, the display generation unit 206 may use these information to correct the superposition position of the AR guidance image Gil.

When the display mode is determined to be the two-dimensional display mode, the display generation unit 206 acquires the information of the two-dimensional position coordinates of the navigation map and generates the route guidance image. The display generation unit 206 determines the superimposed position of the route guidance image with respect to the foreground to a preset position based on the acquisition of the two-dimensional position coordinates. The display generation unit 206 determines the projection shape of the route guidance image based on the two-dimensional position coordinates, and generates the route guidance image. The display generation unit 206 outputs the generated data to the HUD 230 and displays the route guidance image as a virtual image Vi of the non-AR display.

In addition, the display generation unit 206 generates the mode presentation image Ii that presents the display mode of the displayed route guidance image to the occupant. The display generation unit 206 generates, for example, the display mode presentation image Ii as a character image. In the example shown in FIGS. 4 to 6, when the AR guide image Gil is displayed, the display generation unit 206 generates the mode presentation image Ii showing the three-dimensional display mode with the character image of “3D”. When the non-AR guide image Gil is displayed, the display generation unit 206 generates a character image of “2D” as a mode presentation image Ii showing a two-dimensional display mode.

The display generation unit 206 may present the mode presentation image Ii as information other than character information such as symbols and figures. Further, the display generation unit 206 may display the mode presentation image Ii on a display device other than the HUD 230 such as CID 232 and MID 231. In this case, the display generation unit 206 can reduce the amount of information in the projection area PA of the HUD 230 while presenting the display mode to the occupant, and can reduce the annoyance of the occupant. The “display generation unit 206” is an example of the “display mode presentation unit”.

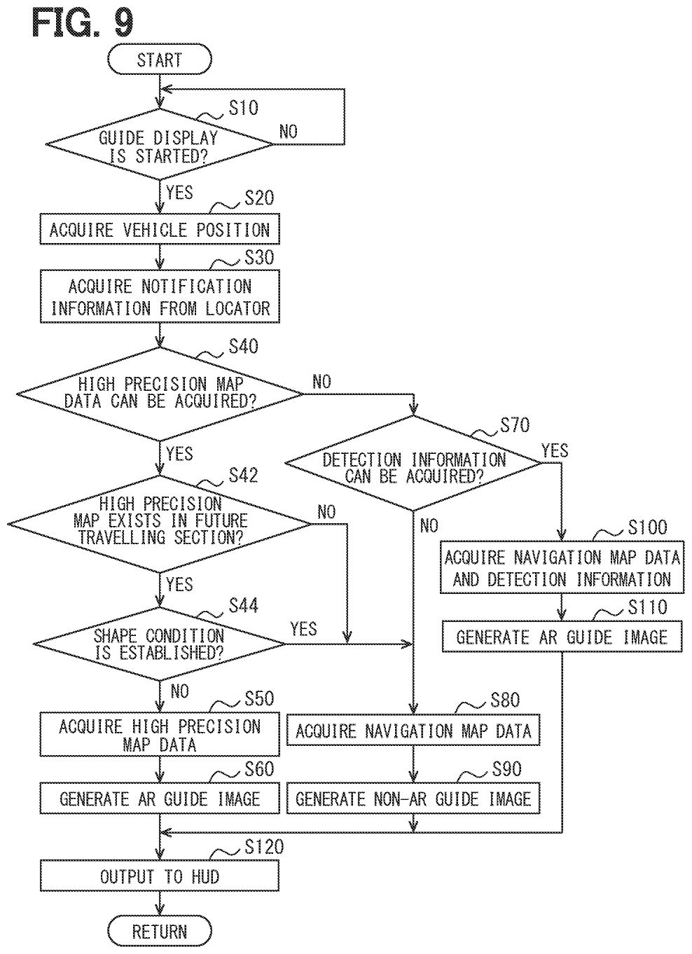

Next, the display process executed by the HCU 20 will be described with reference to the flowchart of FIG. 9. The HCU 20 starts the process of FIG. 9 when the destination is set in the navigation device 7 and the planned travel route is set.

First, in step S10, it is determined whether or not to start the route guidance display. For example, in step S10, it is determined that the route guidance display is started when the distance between the guidance point and the vehicle A is less than the threshold value (for example, 300 meters). When it is determined that the route guidance display is to be started, the process proceeds to step S20, and the vehicle position information is acquired from the locator 3.

Next, in step S30, notification information regarding the position of the own vehicle and its surroundings is acquired from the locator 3, and the process proceeds to step S40. In step 40, it is determined whether or not high-precision map data can be acquired based on the notification information and the like. When it is determined that the acquisition is possible, the process proceeds to step S42.

In step S42, it is determined whether or not there is high-precision map data in the future traveling section GS based on the information from the locator 3. When it is determined that there is high-precision map data in the future traveling section GS, the process proceeds to step S44, and it is determined whether or not the shape condition is satisfied. When it is determined that the shape condition is not satisfied, the process proceeds to step S50.

In step S50, the map information acquisition unit 203 acquires high-precision map data. In step S60, a route guidance image in a three-dimensional display mode is generated based on the three-dimensional coordinates of the acquired high-precision map data, and the process proceeds to step S120. In step S120, the generated route guidance image is output to the HUD 230, and the HUD 230 generates the route guidance image as a virtual image Vi.

On the other hand, when it is determined in step S40 that the high-precision map data cannot be acquired, the process proceeds to step S70. In step S70, it is determined whether or not the detection information can be acquired from the in-vehicle sensor. When it is determined that the detection information cannot be acquired, the process proceeds to step S80.

In step S80, the navigation map data is acquired from the navigation device 7, and the process proceeds to step S90. In step S90, a route guidance image is generated in a two-dimensional display mode based on the navigation map data. After that, the process proceeds to step S120, and the generated route guidance image is output to the HUD 230.

Further, when it is determined in step S42 that the future travel section GS is not included in the high-precision map data, the process proceeds to step S80. In addition, when it is determined in step S44 that the shape condition is satisfied, the process proceeds to step S80.

On the other hand, when it is determined in step S70 that the detection information can be acquired from the peripheral monitoring sensor 4, the process proceeds to step S100. In step S100, navigation map data and detection information are acquired. In step S110, a route guidance image in a three-dimensional display mode is generated based on the navigation map data and the detection information. After that, in step S120, the generated image data is output to the HUD 230.

Next, the configuration and the operation and effect of the HCU 20 of the first embodiment will be described.

The HCU 20 includes a map information acquisition unit 203 that acquires map information regarding the superimposed position of the virtual image Vi in the foreground as high-precision map data or navigation map data, and a display generation unit 206 that generates the virtual image Vi based on the map information. The display generation unit 206 generates a virtual image Vi in a three-dimensional display mode based on the high-precision map data when the high-precision map data can be acquired, and when the high-precision map data cannot be obtained, the display generation unit 206 generates a virtual image Vi in a two-dimensional display mode based on the navigation map data.

According to this, when the high-precision map data can be acquired, the high-precision map data is used to generate the virtual image Vi, and when the high-precision map data cannot be acquired, the low-precision map data is used to generate the virtual image Vi. This makes it possible to display the virtual image Vi by properly using the high-precision map data and the low-precision map information. From the above, it is possible to provide the HCU 20 and the display control program that can effectively use the map information. In the three-dimensional display mode, the display generation unit 206 superimposes the virtual image Vi on the road surface which is a specific superimposition target in the foreground, and does not superimpose the virtual image Vi on the road surface in the two-dimensional display mode. As a result, the HCU 20 can avoid superimposing the virtual image Vi on the road surface based on the navigation map data with relatively low accuracy. Therefore, the HCU 20 can suppress the occurrence of a shift in the display position due to the superimposed display of the virtual image Vi based on the map information with low accuracy.

When the high-precision map data does not include information about the future traveling section GS of the vehicle A, the display generation unit 206 generates a virtual image Vi in the two-dimensional display mode even if the high-precision map data can be available. According to this, even if the high-precision map data can be acquired at the current position, when there is no high-precision map data at the guide point, the virtual image Vi is not generated in the three-dimensional display mode. Therefore, it is possible to avoid changing the display mode of the virtual image Vi from the three-dimensional display mode to the two-dimensional display mode in the vicinity of the guide point. Therefore, the HCU 20 can suppress the annoyance to the occupant by changing the display mode of the virtual image Vi.

The display generation unit 206 generates the virtual image Vi in a two-dimensional display mode even if the high-precision map data can be acquired even when the shape condition for stopping the generation of the virtual image Vi in the three-dimensional display mode is satisfied with respect to the road shape on which the vehicle A travels. According to this, the HCU 20 can generate a virtual image Vi in a two-dimensional display mode when the traveling road has a road shape in which information can be relatively easily provided to the occupants in the virtual image Vi in the two-dimensional display mode. As a result, the HCU 20 can suppress the complexity of processing due to the use of high-precision map data while transmitting the information of the virtual image Vi to the occupants.

The HCU 20 includes a sensor information acquisition unit 204 that acquires detection information from the peripheral monitoring sensor 4. When the display generation unit 206 cannot acquire the high-precision map data and the sensor information acquisition unit 204 can acquire the detection information, the display generation unit 206 generates the virtual image Vi is in the three-dimensional display mode based on the combination of the navigation map data and the detection information. According to this, even when the high-precision map data cannot be acquired, the HCU 20 can combine the navigation map data with the detection information to generate the virtual image Vi in a display mode similar to the display mode based on the high-precision map data.

The display generation unit 206 presents to the occupant whether the virtual image Vi is generated in the three-dimensional display mode or the two-dimensional display mode. According to this, the HCU 20 can present the display mode of the virtual image Vi more directly to the occupant. Therefore, the HCU 20 can promote the occupant to understand the information shown by the virtual image Vi.

The map information acquisition unit 203 acquires map information including at least one of road gradient information, three-dimensional shape information of lane markings, and information on which the road gradient can be estimated as the high-precision map data. According to this, the HCU 20 can acquire or estimate the slope information of the road and generate a virtual image Vi in a three-dimensional display mode. Therefore, the HCU 20 can more reliably suppress the deviation of the display position of the virtual image Vi in the three-dimensional display mode.

### Second Embodiment

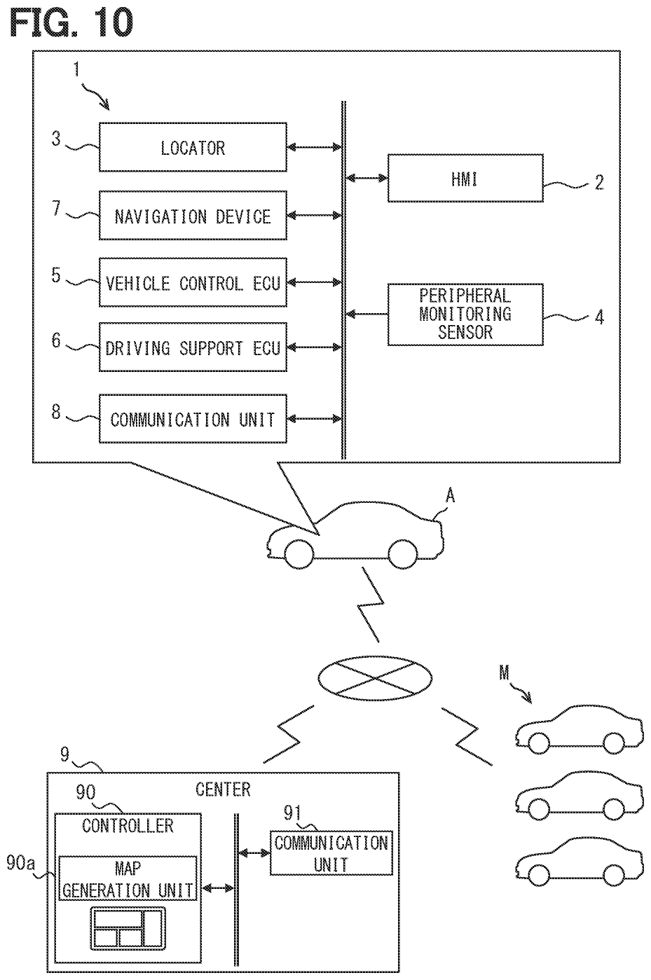

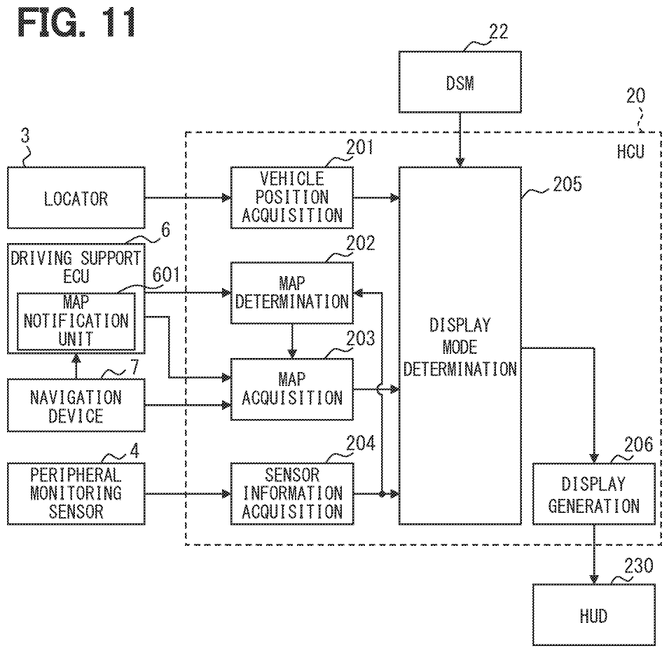

In the second embodiment, a modification of the HCU 20 in the first embodiment will be described. In FIGS. 10 and 11, components denoted by the same reference numerals as those in the drawings of the first embodiment are the same components and exert similar operational effects.

In the first embodiment, the HCU 20 acquires the high-precision map data stored in the locator 3. Instead, the HCU 20 may acquire probe map data as high-precision map information.

The center 9 receives probe information transmitted from a plurality of probe vehicles M by the communication unit 91 and stores it in the control unit 90. The probe information is information acquired by the peripheral monitoring sensor 4 or the locator 3 of each probe vehicle M, and represents the traveling locus of the probe vehicle M, road shape information, and the like in three-dimensional position coordinates.

The control unit 90 mainly includes a microcomputer including a processor, a RAM, a memory device, I/O, and a bus for connecting them. The control unit 90 includes a map generation unit 90a as a functional block. The map generation unit 90a generates the probe map data based on the acquired probe information. Since the probe information is data including three-dimensional position coordinates, the generated probe map data is three-dimensional map data including height information of each point.

The vehicle system 1 communicates with the center 9 via the wireless communication network in the communication unit 8 and acquires probe map data. The communication unit 8 stores the acquired probe map data in the driving support ECU 6.

The driving support ECU 6 has a map notification unit 601 as a functional block. Similar to the map notification unit 301 of the locator 3 in the first embodiment, the map notification unit 601 determines whether or not the probe ma data includes the information on the own vehicle position and the surrounding area based on the measured vehicle position and the information acquired from the navigation device 7. When the map notification unit 601 determines that the probe map data includes information on the position of the own vehicle and the area around it, the map notification unit 601 outputs the information to the HCU 20 as notification information.

The map information acquisition unit 203 of the HCU 20 acquires the probe map data from the driving support ECU 6 when the map determination unit 202 determines that the probe map data which is high-precision map information can be acquired. The display generation unit 206 generates the AR guide image Gil based on the probe map data.

### Third Embodiment

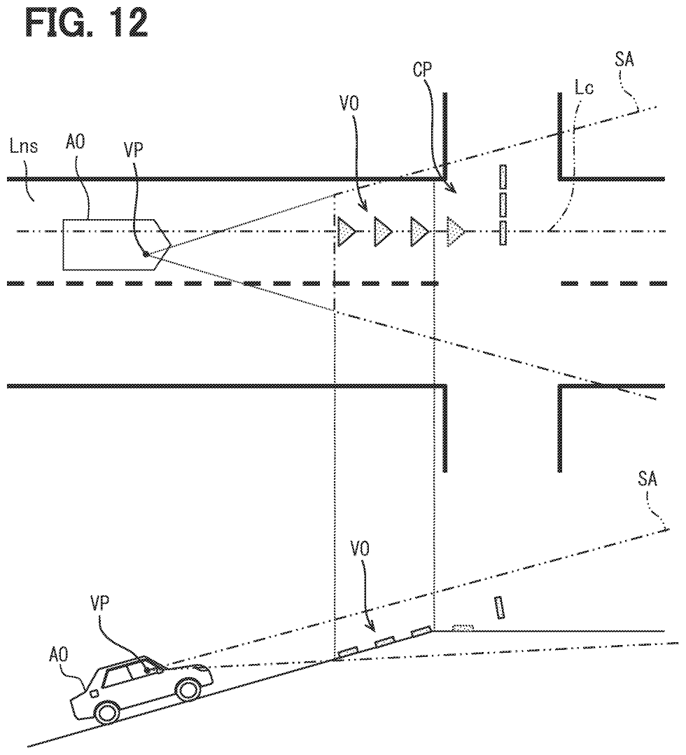

In the third embodiment, a modification of the HCU 20 in the first embodiment will be described. In FIGS. 12 to 17, the same components with the same signs as in the drawings of the first embodiment achieve the same operations and effects.

In the first display mode, the HCU 20 of the third embodiment superimposes and displays the route guidance image on the road surface at the superposed position based on the high-precision map data, and in the second display mode, superimposes and displays the route guidance image on the road surface at the superposed position based on the navigation map data. In the following, the route guidance image of the first display mode will be referred to as a first AR guide image CT1, and the route guide image of the second display mode will be referred to as a second AR guide image CT2.

The display mode determination unit 205 determines the display of the first AR guide image CT1 when the high-precision map data can be acquired, and when the high-precision map data cannot be acquired and the navigation map data can be acquired, the unit 205 determines the display of the second AR guide image CT2.

Here, when the freshness condition determined for the newness (i.e., freshness) of the high-precision map data is satisfied, the display mode determination unit 205 determines to display the second AR guide image CT2 even if the high-precision map data can be acquired. The freshness condition is satisfied, for example, when the high-precision map data is older than the navigation map data.

In addition, the display mode determining unit 205 evaluates the magnitude of the shift of the superimposed position when displaying in the second display mode based on various acquired information. The display mode determination unit 205 evaluates the magnitude of the superimposed position shift based on, for example, the positioning accuracy of the own vehicle position and the presence/absence of the feature recognition information.

The display mode determining unit 205 determines whether or not the positioning accuracy of the position of the own vehicle is equal to or higher than a predetermined level. Specifically, the display mode determination unit 205 evaluates the position of the own vehicle acquired from the locator 3 based on the detection information acquired from the peripheral monitoring sensor 4. For example, the display mode determining unit 205 detects the intersection CP from the image captured by the front camera 41 and analyzes the relative position of the vehicle A with respect to the intersection CP. Then, the display mode determining unit 205 determines whether or not the magnitude of the deviation between the position of the vehicle A specified from the relative position and the map data and the position of the own vehicle acquired from the locator 3 is equal to or higher than a predetermined level. The display mode determining unit 205 may detect an object other than the intersection CP capable of specifying the position of the vehicle A from the captured image and perform the above processing. The display mode determination unit 205 may acquire the analysis result of the captured image from another ECU such as the driving support ECU 6.

The display mode determination unit 205 may determine whether or not the evaluation value of the positioning accuracy based on the residual of the pseudo distance, the number of positioning satellites captured by the locator 3, the S/N ratio of the positioning signal, and the like is equal to or higher than a predetermined level.

The display mode determination unit 205 determines whether or not the feature recognition information is acquired from the peripheral monitoring sensor 4. The feature recognition information is the information for recognizing the feature by the peripheral monitoring sensor 4, and is information that can be used to correct the superposed position in the front-rear and left-right directions of the vehicle A. The features include, for example, road markings such as stop lines, central markings at intersections, and lane markings. By correcting the position of the own vehicle on the map data based on the relative position of these features with respect to the vehicle A, it is possible to correct the superposed position of the second AR guide image CT2 in the front-rear and left-right directions. In addition to road markings, road boundaries such as curbs and road installations such as sign boards may be included in features that can be used to correct the position of the vehicle.

The display mode determination unit 205 evaluates the magnitude of the superimposed position shift of the second AR guide image CT2 to be displayed based on the combination of the above various information, that is, the combination of the high and low positioning accuracy of the own vehicle position and the presence/absence of the feature recognition information. For example, the display mode determination unit 205 classifies the magnitude of the superposition position deviation into three levels of “small”, “medium”, and “large” according to the combination.

Specifically, the display mode determination unit 205 determines that the magnitude of the deviation is small when the positioning accuracy is equal to or higher than a predetermined level and there is feature recognition information. When the positioning accuracy is equal to or higher than a predetermined level and there is no feature recognition information, the display mode determining unit 205 determines that the deviation is medium. The display mode determination unit 205 determines that the degree of deviation is medium even when the positioning accuracy is less than a predetermined level and there is feature recognition information. When the positioning accuracy is less than a predetermined level and there is no feature recognition information, the display mode determining unit 205 determines that the magnitude of the deviation is large.

The display mode determination unit 205 provides the display mode determination result and the magnitude of the deviation evaluated in the case of the second display mode to the display generation unit 206 together with the information necessary for generating the route guidance image.

The display generation unit 206 generates either the first AR guide image CT1 or the second AR guide image CT2 based on the information provided by the display mode determination unit 205. The AR guide images CT1 and CT2 indicate the planned travel route of the vehicle A at the guide point by AR display. The AR guide images CT1 and CT2 are AR virtual images which has the road surface as the superimposition target as in the first embodiment. As an example, in the case of a scene that guides a right/left turn (e.g., the left turn in the drawing) at an intersection CP in a traveling area including an intersection CP, each AR guide image CT1 and CT2 includes an approach route content CTa indicating an approach route to the intersection CP, the exit route content CTe indicating the exit route from the intersection CP. The approach route content CTa is, for example, a plurality of triangular objects arranged along the planned travel route. The exit route content CTe is a plurality of arrow-shaped objects arranged along the planned travel route.

When generating the first AR guide image CT1, the display generation unit 206 determines the superimposed position and the superimposed shape of the first AR guide image CT1 by using the high-precision map data. Specifically, the display generation unit 206 utilizes various position information such as the road surface position based on the high-precision map data, the own vehicle position by the locator 3, the viewpoint position of the occupant by the DSM 22, and the positional relationship of the set projection area PA. The display generation unit 206 calculates the superposed position and superposed shape of the first AR guide image CT1 by geometric calculation based on the various position information.

More specifically, the display generation unit 206 reproduces the current traveling environment of the vehicle A in the virtual space based on the own vehicle position information based on the high-precision map data, the high-precision map data, the detection information, and the like. More specifically, as shown in FIG. 12, the display generation unit 206 sets the own vehicle object AO at a reference position in a virtual three-dimensional space. The display generation unit 206 maps the road model of the shape indicated by the map data in the three-dimensional space in association with the own vehicle object AO based on the own vehicle position information.

The display generation unit 206 sets the virtual camera position VP and the superimposition range SA in association with the own vehicle object AO. The virtual camera position VP is a virtual position corresponding to the viewpoint position of the occupant. The display generation unit 206 sequentially corrects the virtual camera position VP with respect to the own vehicle object AO based on the latest viewpoint position coordinates acquired from the DSM 22. The superimposition range SA is a range in which the virtual image Vi can be superposed and displayed. The display generation unit 206 sets the front range inside the image forming plane as the superimposition range SA when viewing the front side from the virtual camera position VP based on the virtual camera position VP and the outer edge position (i.e., coordinates) information of the projection area PA stored in advance in the storage unit 13 (see FIG. 1) or the like. The superimposition range SA corresponds to the projection region PA and the angle of view of the HUD 230.

The display generation unit 206 arranges a virtual object VO that imitates the first AR guide image CT1 in the virtual space. The virtual object VO is arranged along the planned travel route on the road surface of the road model in the three-dimensional space. The virtual object VO is set in the virtual space when the first AR guide image CT1 is displayed as a virtual image. The virtual object VO defines the position and shape of the first AR guide image CT1. That is, the shape of the virtual object VO seen from the virtual camera position VP becomes the virtual image shape of the first AR guide image CT1 visually recognized from the viewpoint position.

The display generation unit 206 arranges the virtual object VO on the own lane Lns at the central portion Lc of the own lane Lns in the lane width direction. The central portion Lc is, for example, an intermediate point between the lane boundaries on both sides defined by the traveling lanes or the road edges of the own lane Lns.

As a result, the superimposed position of the approach route content CTa is set to the substantially central portion Lc of the own lane Lns (see FIG. 3). When the current driving lane Lns and the approach lane to the intersection CP are different, the approach route content CTa is displaced from the center of the own lane Lns to the center of the approach lane, and the approach route content CTa may be displayed so as to extend to follow the center of the approach lane.

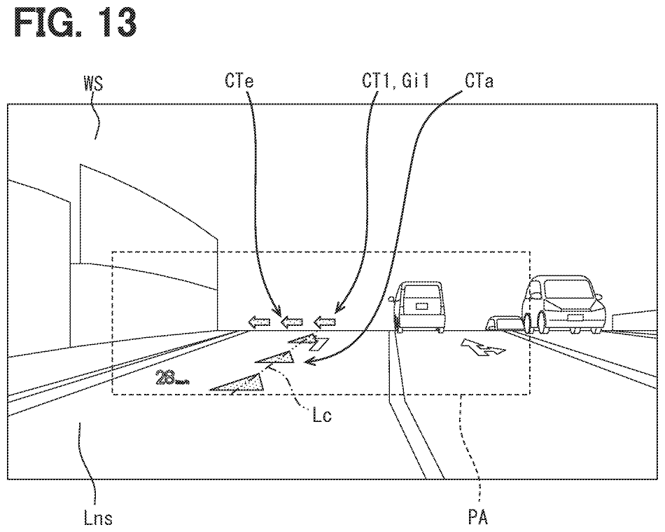

Further, the exit route content CTe is arranged along the planned travel route so as to be aligned along the approach route content CTa. The exit route content CTe is superimposed at a position floating from the road surface in the intersection CP and the central portion of the exit lane. As shown in FIG. 13, the superimposition position of the exit route content CTe is determined so that, when the road surface to be superposed is not visible, the content CTe is visually recognized to float above the upper end of the road surface within the angle of view.

The display generation unit 206 starts displaying the above first AR guide image CT1 when the remaining distance to the intersection CP is less than the threshold value (for example, 300 meters). The display generation unit 206 sequentially updates the superimposition position and superimposition shape of the first AR guide image CT1 so that the image CT1 is displayed as if it is relatively fixed to the road surface. That is, the display generation unit 206 displays the first AR guide image CT1 to be movably displayed on the occupant's appearance so as to follow the road surface that relatively moves with the traveling of the vehicle A.

When generating the second AR guide image CT2, the display generation unit 206 determines the superimposition position and superimposition shape of the second AR guide image CT2 by using the navigation map data instead of the high-precision map data. In this case, the display generation unit 206 sets the road surface position under the assumption that the road surface to be superimposed is a flat road surface without undulations. For example, the display generation unit 206 sets the horizontal road surface as the virtual road surface to be superimposed, and performs geometric calculations based on the virtual road surface position and various other position information to calculate the superimposed position and the superimposed shape of the second AR guide image CT2.

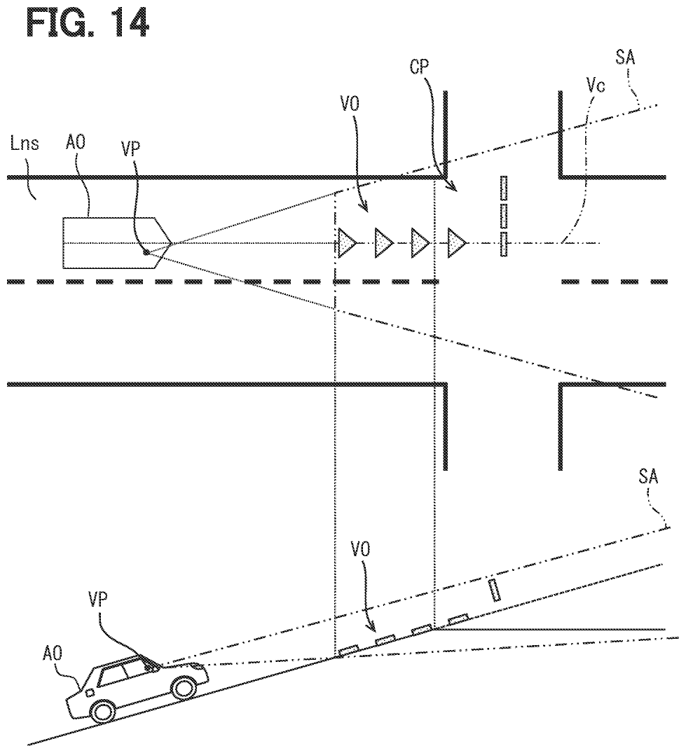

Therefore, the virtual road surface set by the display generation unit 206 in this case may be more unclear as compared with the one set based on the high-precision map data. For example, as shown in FIG. 14, in the case of a road shape in which a flat intersection CPs having no slope is connected to an uphill road surface, the virtual road surface of the intersection CP portion may be deviated from the actual road surface. In the example of FIG. 14, in order to clearly indicate the deviation of the virtual road surface at the intersection CP portion, the shape of the virtual road surface reflects the uphill slope, but in reality, the uphill slope may not be always reflected on the virtual road surface.

In the generation of the second AR guide image CT2, the display generation unit 206 determines the position of the virtual object VO in the virtual space in the left-right direction based on the magnitude of the deviation. Specifically, when the magnitude of the deviation is a small level, the display generation unit 206 arranges the virtual object VO at the vehicle center position Vc, which is a position within the superimposition range SA corresponding to the center of the vehicle A. Here, the vehicle center position Vc is the position of the straight line within the superimposition range SA when a virtual straight line that passes through the center of the vehicle A in the vehicle width direction and extends in the front-rear direction of the vehicle A is assumed on the virtual road surface. As a result, the approach route content CTa is arranged so as to be inclined with respect to the up-down direction of the projection area PA, as shown in FIG. 5.

Then, when the magnitude of the deviation is a medium level or a large level, the display generation unit 206 arranges the second AR guide image CT2 in the central portion Ac in the left-right direction of the projection region PA. In this case, as shown in FIG. 6, the approach route content CTa is displayed in a state of being arranged side by side in the vertical direction of the projection area PA.

Further, when the display generation unit 206 has the feature recognition information, the display generation unit 206 corrects the superimposed position based on the feature recognition information. For example, the display generation unit 206 corrects the position of the own vehicle, based on the feature recognition information, in the front-rear, and left-right directions on the virtual road surface set based on the navigation map data, and then calculates the superimposed position and the superimposed shape of the second AR guide image CT2.

When the display generation unit 206 has height correction information which is height information other than the map data, the display generation unit 206 corrects the superposed position based on the height correction information. The height correction information is, for example, three-dimensional position information of the roadside device acquired by road-to-vehicle communication. In this case, the display generation unit 206 may acquire information via the V2X communication device mounted on the vehicle A. The display generation unit 206 may acquire or the height correction information may be the height information of the object detected by the peripheral monitoring sensor 4. That is, when the three-dimensional position information such as the road installation object and the road signs can be specified by the analysis of the detection information of the peripheral monitoring sensor 4, the height information included in the three-dimensional position information may be included in the height correction information. The display generation unit 206 changes the position and shape of the virtual road surface from the horizontal road surface based on the height correction information, for example, so that the superimposition position of the second AR guide image CT2 in the height direction virtually arranged on the virtual road surface.

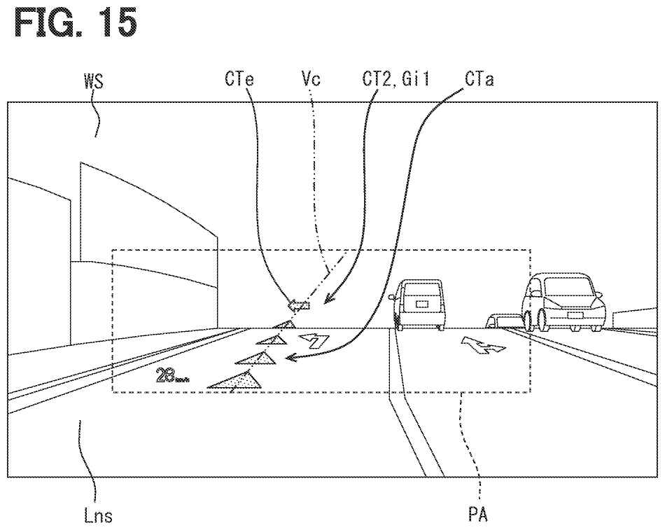

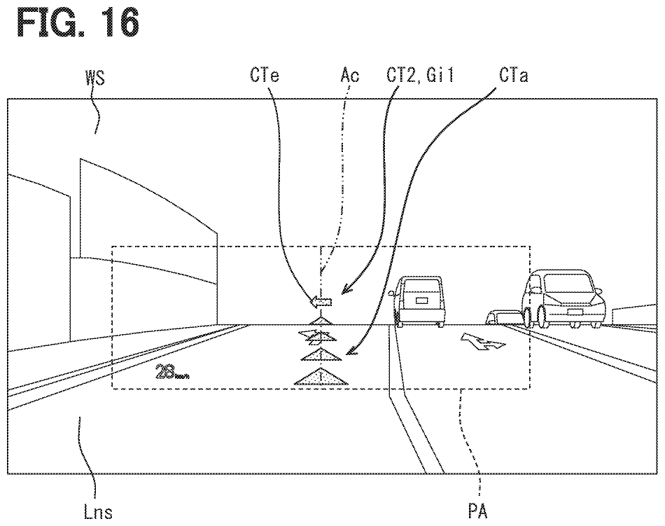

In addition, the display generation unit 206 limits the superimposed display of the second AR guide image CT2 to the front side of the planned travel route with respect to the first AR guide image CT1. Specifically, the display generation unit 206 hides the part of the exit route content CTe of the second AR guide image CT2 that is superimposed on the side of the planned travel route farther from the vehicle A than the first AR guide image CT1, and displays only the superimposed part on the front side. In the examples shown in FIGS. 15 and 16, when the first AR guide image CT1 is displayed, three exit route contents CTe are displayed, whereas when the second AR guide image CT2 is displayed, only one exit route content CTe arranged on the front side is displayed. That is, the second AR guide image CT2 is a content that presents the exit direction from the intersection CP and does not present the path of the exit route, and is simpler than the first AR guide image CT1.

The display generation unit 206 starts displaying the above-mentioned second AR guide image CT2 at a timing different from that of the first AR guide image CT1. Specifically, the display generation unit 206 displays the non-AR guide image Gi2 instead of the second AR guide image CT2 when the remaining distance to the intersection CP falls below the first threshold value. Then, when the remaining distance falls below the second threshold value (for example, 100 meters) smaller than the first threshold value, the display generation unit 206 switches the display from the non-AR guide image Gi2 to the second AR guide image CT2. That is, the display generation unit 206 starts displaying the second AR guide image CT2 at a stage closer to the intersection CP than when displaying the first AR guide image CT1. The threshold value for displaying the non-AR guide image Gi2 may not be the first threshold value as long as it is larger than the second threshold value.

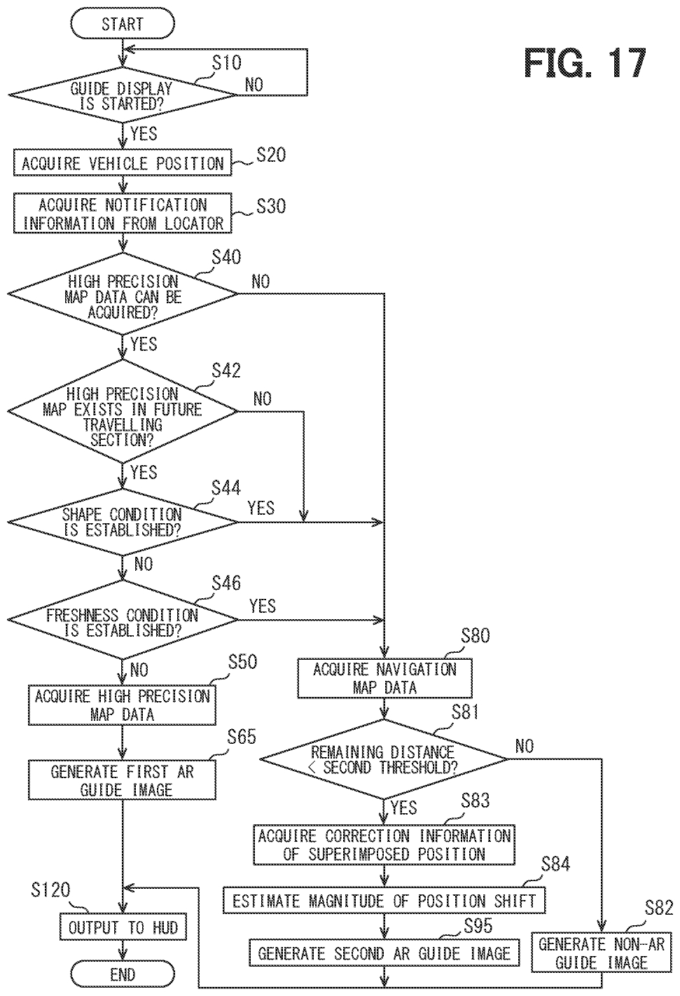

Next, the display process executed by the HCU 20 will be described with reference to the flowchart of FIG. 17. Of the processes shown in FIG. 17, the description of the steps having the same reference numerals as those in the flowchart of FIG. 9 will be omitted as appropriate.

When it is determined in step S44 that the shape condition is not satisfied, the HCU 20 proceeds to step S46. In step S46, the display mode determination unit 205 determines the freshness condition of the high-precision map data. When it is determined that the freshness condition is not satisfied, the process proceeds to step S50, and when it is determined that the freshness condition is satisfied, the process proceeds to step S80.

When the high-precision map data is acquired in step S50, the process proceeds to step S65, and the display generation unit 206 generates the first AR guide image CT1. On the other hand, when the navigation map data is acquired in step S80, the process proceeds to step S81.

In step S81, the display generation unit 206 determines whether or not the remaining distance to the intersection CP is less than the second threshold value. When it is determined that the threshold value is not lower than the second threshold value, the process proceeds to step S82, the non-AR guide image Gil is generated, and then the process proceeds to step S120. On the other hand, when it is determined in step S81 that the threshold value falls below the second threshold value, the process proceeds to step S83. In step S83, the display mode determination unit 205 or the like acquires the correction information of the superposed position via the sensor information acquisition unit 204. When there is no correction information that can be acquired, step S83 is skipped.

Next, in step S84, the display mode determining unit 205 evaluates the magnitude of the positional deviation of the second AR guide image CT2, and proceeds to step S95. In step S95, the display generation unit 206 generates the second AR guide image CT2 based on the acquired navigation map data, correction information, information on the magnitude of misalignment of the position, and the like.

According to the third embodiment described above, in the first display mode, the first AR guide image CT1 is superimposed and displayed on the road surface at the superimposed position based on the high-precision map information. Then, in the second display mode, the second AR guide image CT2 is superimposed and displayed at the superimposed position based on the navigation map data. Therefore, the HCU 20 can superimpose and display the virtual image Vi on a specific superimposing target while properly using the map data in both the area where the high-precision map data can be used and the area where the high-precision map data cannot be used.

Further, the display generation unit 206 starts displaying the second AR guide image CT2 when the remaining distance to the intersection CP reaches the second threshold value shorter than the first threshold value at which the first AR guide image CT1 is started to be displayed. Since the intersection CP is often a relatively flat terrain, the display generation unit 206 starts displaying the second AR guide image CT2 at a stage closer to the intersection CP than the display scene of the first AR guide image CT1, so that the magnitude of the misalignment of the position of the second AR guide image CT2 can be suppressed. Alternatively, the display generation unit 206 may shorten the traveling section in which the misalignment of the second AR guide image CT2 becomes large.

### Other Embodiments

The present disclosure in the present specification is not limited to the illustrated embodiments. The present disclosure encompasses the illustrated embodiments and modifications based on the embodiments by those skilled in the art. For example, the present disclosure is not limited to the combinations of components and/or elements shown in the embodiments. The present disclosure may be implemented in various combinations. The present disclosure may have additional portions that may be added to the embodiments. The present disclosure encompasses omission of components and/or elements of the embodiments. The present disclosure encompasses the replacement or combination of components and/or elements between one embodiment and another. The disclosed technical scope is not limited to the description of the embodiments.

In the above-described embodiments, the display generation unit 206 generates the AR guide image Gil as a route guide image based on the high-precision map information, and generates the non-AR guide image Gil as a route guide image based on the navigation map data. Alternatively or in addition to this, the display generation unit 206 may be configured to generate different display modes depending on the map information for acquiring the virtual image Vi other than the route guidance image. For example, the display generation unit 206 may superpose and display an image that promotes the occupant's attention to an object (for example, a preceding vehicle, a pedestrian, a road sign, etc.) to be watched when the high-precision map information can be obtained. When the high-precision map information cannot be obtained, the unit 206 may interrupt superimposing the image on the object.

In the above-described embodiment, the display generation unit 206 displays the mode presentation image Ii together with the route guidance image. Alternatively, the mode presentation image Ii may be started to be displayed before the route guidance image is displayed.

In the first embodiment, the HCU 20 displays the non-AR guide image Gi2 based on the navigation map data when the shape condition is satisfied. Instead of this, the HCU 20 may display the non-AR guide image Gi2 based on the high-precision map data when the shape condition is satisfied and the high-precision map data can be acquired.

In the third embodiment, the display generation unit 206 sets the superimposed position of the second AR guide image CT2 to be one of the vehicle center position Vc and the central portion Ac of the projection area PA according to the magnitude of the superimposed position shift of the second AR guide image CT2. Instead of this, the display generation unit 206 may be configured to superimpose on only one of them.

In the third embodiment, the display generation unit 206 switches from the non-AR guide image Gi2 to the second AR guide image CT2 based on the remaining distance to the intersection CP. Alternatively, the conditions for switching may not be limited to this. For example, the display generation unit 206 may be configured to switch when the correction information regarding the superimposed position of the second AR guide image CT2 can be acquired. Here, the correction information is information that can be used for correcting the superposed position of the second AR guide image CT2, for example, the position information such as a stop line of the intersection CP, a central marking of the intersection CP, a road marking of another lane Lns, and the like. The correction information is acquired as an analysis result of the detection information of the peripheral monitoring sensor 4.

In the above-described embodiments, the display generation unit 206 generates the route guidance image in the second display mode when the high-precision map data does not include the information about the future traveling section GS. The display generation unit 206 may be configured to generate a route guidance image in the first display mode as long as the high-precision map data corresponding to the current position of the vehicle can be acquired. In this case, the display generation unit 206 may switch from the first display mode to the second display mode when the high-precision map data corresponding to the current position of the vehicle cannot be acquired.

In addition, when the display mode is switched as described above, the display generation unit 206 of the third embodiment displays the route guide image to be displaced continuously from the superposed position of the first AR guide image CT1 to the superposed position of the second AR guide image CT2. As a result, the display generation unit 206 can reduce the discomfort of the occupant due to the momentary switching of the superposition position. It may be desirable that the moving speed of the route guidance image at this time is so slow that the movement of the route guidance image itself does not induce the consciousness of the occupants.

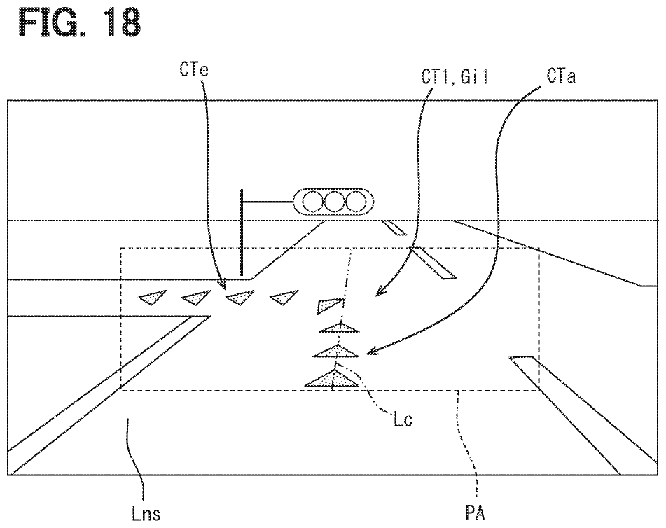

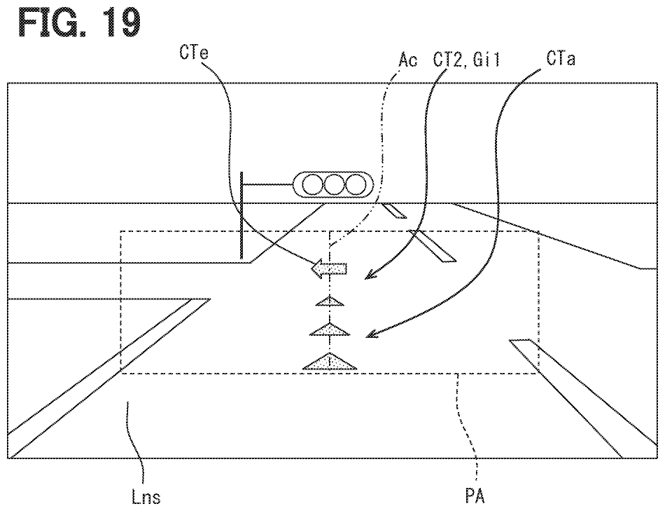

In the third embodiment, the display generation unit 206 displays the approach route content CTa and the exit route content CTe of the first AR guide image CT1 with contents having different shapes. Instead, the display generation unit 206 may make the contents CTa and CTe substantially the same shape as the contents as shown in FIG. 18. In the example shown in FIG. 18, each content CTa and CTe has a shape of a plurality of triangles arranged along the planned travel route. In this case, the display generation unit 206 may change the exit route content CTe to an arrow-shaped image indicating the exit direction in the display of the second AR guide image CT2 (see FIG. 19). The display generation unit 206 may display the route guidance image as strip-shaped content extending continuously along the planned travel route. In this case, the second AR guide image CT2 may be displayed in a manner limited to the length to the front side of the planned travel route before the first AR guide image CT1.

The processor of the above-described embodiment is a processing unit including one or a plurality of CPUs (Central Processing Units). Such a processor may be a processing unit including a GPU (Graphics Processing Unit), a DFP (Data Flow Processor), and the like in addition to the CPU. Further, the processor may be a processing unit including an FPGA (Field-Programmable Gate Array) and an IP core specialized in specific processing such as learning and inference of AI. Each arithmetic circuit unit of such a processor may be individually mounted on a printed circuit board, or may be mounted on an ASIC (Application Specific Integrated Circuit), an FPGA, or the like.

As a memory device for storing a display control program or the like, various non-transitional tangible storage medium (non-transitory tangible storage medium) such as a flash memory and a hard disk can be adopted. The form of such a storage medium may be appropriately changed. For example, the storage medium may be in the form of a memory card or the like, and may be inserted into a slot portion provided in the in-vehicle ECU and electrically connected to the control circuit.

The control unit and the method described in the present disclosure may be implemented by a special purpose computer configuring a processor programmed to perform one or more functions embodied by a computer program. Alternatively, the device and the method described in the present disclosure may be implemented by a dedicated hardware logic circuit. Alternatively, the device and the method described in the present disclosure may be implemented by one or more dedicated computers configured by a combination of a processor executing a computer program and one or more hardware logic circuits. The computer programs may be stored, as instructions to be executed by a computer, in a tangible non-transitory computer-readable storage medium.

The control unit and the method thereof described in the present disclosure are realized by a dedicated computer provided by configuring a processor and a memory programmed to execute one or more functions embodied by a computer program. Alternatively, the control unit and the method described in the present disclosure may be realized by a dedicated computer provided by configuring a processor with one or more dedicated hardware logic circuits. Alternatively, the control unit and the method thereof described in the present disclosure are based on a combination of a processor and a memory programmed to execute one or more functions and a processor configured by one or more hardware logic circuits. It may be realized by one or more configured dedicated computers. The computer programs may be stored, as instructions to be executed by a computer, in a tangible non-transitory computer-readable storage medium.

Here, the process of the flowchart or the flowchart described in this application includes a plurality of sections (or steps), and each section is expressed as, for example, S10. Further, each section may be divided into several subsections, while several sections may be combined into one section. Furthermore, each section thus configured may be referred to as a device, module, or means.

Although the present disclosure has been described in accordance with the examples, it is understood that the disclosure is not limited to such examples or structures. The present disclosure also includes various modifications and modifications within an equivalent range. In addition, various combinations and forms, and further, other combinations and forms including only one element, or more or less than these elements are also within the sprit and the scope of the present disclosure.

What is claimed is:

1. A display control device for a vehicle that controls displaying a virtual image superimposed on a foreground scenery of an occupant, the display control device comprising:
a vehicle position acquisition unit that acquires a position of the vehicle;
a map information acquisition unit that acquires high-precision map information or low-precision map information with lower accuracy than the high-precision map information, corresponding to the position; and
a display generation unit that generates the virtual image in a first display mode based on the high-precision map information when the high-precision map information can be acquired, and generates the virtual image in a second display mode different from the first display mode based on the low-precision map information when the high-precision map information cannot be acquired, wherein:
the display generation unit displays the virtual image in the second display mode in a smaller region of a projection area of the virtual image than the first display mode.

2. The display control device according to claim 1, wherein:
the display generation unit superimposes the virtual image on a specific superimposing target in the foreground scenery in the first display mode, and stops superimposing the virtual image on the specific superimposing target in the second display mode.

3. The display control device according to claim 2, wherein:
the display generation unit generates the virtual image whose superimposition on the specific superimposing target is stopped based on the high-precision map information when a shape condition to stop generating the virtual image in the first display mode is satisfied with respect to a road shape on which the vehicle travels, and the high-precision map information can be acquired.

4. The display control device according to claim 1, wherein:
the display generation unit superimposes the virtual image on a specific superposing target in the foreground scenery at a superposition position based on the high-precision map information in the first display mode, and superimposes the virtual image on the specific superimposing target at a superimposition position based on the low-precision map information.

5. The display control device according to claim 4, wherein:
the virtual image includes a route guidance image for presenting a travel plan route of the vehicle in a traveling area including an intersection; and
the display generation unit sets a remaining distance to the intersection at which the display generation unit starts generating the route guidance image in the second display mode to be shorter than the remaining distance at which the display generation unit starts generating the route guidance image in the first display mode.

6. The display control device according to claim 4, wherein:
the display generation unit superimposes and displays the virtual image in the second display mode on the specific superimposing target disposed in an area which is limited to be closer to the vehicle than the first display mode.

7. The display control device according to claim 4, wherein:
the display generation unit superimposes and displays the virtual image in the second display mode on the specific superimposing target which is limited to be disposed before the first display mode.

8. The display control device according to claim 4, wherein:
the virtual image includes a route guidance image for presenting a travel plan route of the vehicle in a traveling area including an intersection; and
the route guidance image in the first display mode indicates a change of a direction of the travel plan route at the intersection and an exit direction from the intersection; and
the route guidance image in the second display mode indicates only the exit direction from the intersection.

9. The display control device according to claim 1, further comprising:
a mode presentation unit that presents to the occupant whether the virtual image is generated in the first display mode or the second display mode.

10. A display control device for a vehicle that controls displaying a virtual image superimposed on a foreground scenery of an occupant, the display control device comprising:
a vehicle position acquisition unit that acquires a position of the vehicle;
a map information acquisition unit that acquires high-precision map information or low-precision map information with lower accuracy than the high-precision map information, corresponding to the position; and
a display generation unit that generates the virtual image to be superimposed on a road surface as a specific superimposing target in a first display mode based on the high-precision map information when the high-precision map information can be acquired, and generates the virtual image to be superimposed on the road surface as the specific superimposing target in a second display mode different from the first display mode based on the low-precision map information when the high-precision map information cannot be acquired, wherein:
the display generation unit superimposes and displays the virtual image at a superimposing position of the road surface in the first display mode different from the second display mode.

11. The display control device according to claim 10, wherein:
the display generation unit superimposes and displays a specific content as the virtual image on the road surface before a travel plan route of the vehicle at a superimposing position in the first display mode different from the second display mode; and
the display generation unit superimposes and displays another specific content as the virtual image on the road surface ahead of the specific content along the travel plan route at a superimposing position in a front-rear direction of the vehicle in the first display mode same as the second display mode.

12. The display control device according to claim 10, wherein:
the display generation unit superimposes and displays the virtual image in the first display mode at a central portion of a traffic lane; and
the display generation unit superimposes and displays the virtual image in the second display mode at a position on a virtual straight line passing through a center of the vehicle in a vehicle width direction and extending in a front-rear direction of the vehicle or at a central portion of a projection area of the virtual image in a right-left direction of the projection area.

13. The display control device according to claim 12, wherein:
the display generation unit determines the superimposing position of the virtual image in the second display mode based on a level of a positioning accuracy of a position of the vehicle.

14. The display control device according to claim 10, further comprising:
a mode presentation unit that presents to the occupant whether the virtual image is generated in the first display mode or the second display mode.

15. A display control device for a vehicle that controls displaying a virtual image superimposed on a foreground scenery of an occupant, the display control device comprising:
a vehicle position acquisition unit that acquires a position of the vehicle;
a map information acquisition unit that acquires high-precision map information or low-precision map information with lower accuracy than the high-precision map information, corresponding to the position;
a display generation unit that generates the virtual image to be superimposed on a road surface as a specific superimposing target in a first display mode based on the high-precision map information when the high-precision map information can be acquired, and generates the virtual image to be superimposed on the road surface as the specific superimposing target in a second display mode different from the first display mode based on the low-precision map information when the high-precision map information cannot be acquired; and
a mode presentation unit that presents to the occupant whether the virtual image is generated in the first display mode or the second display mode.

16. The display control device according to claim 15, wherein:
the display generation unit superimposes and displays the virtual image in the second display mode when the map information acquisition unit can not acquire the high-precision map information in a future traveling section of the vehicle even if the map information acquisition unit acquires the high-precision map information at a starting point where he display generation unit starts displaying the virtual image.

17. The display control device according to claim 15, wherein:
the display generation unit superimposes and displays the virtual image in the first display mode on the specific superimposing target of the foreground scenery of the occupant; and
the display generation unit superimposes and displays the virtual image in the second display mode at a fixed position of a projection member of the virtual image.

18. The display control device according to claim 10, wherein:
the virtual image includes a route guidance image for presenting a travel plan route of the vehicle in a traveling area including an intersection; and
the display generation unit sets a remaining distance to the intersection at which the display generation unit starts generating the route guidance image in the second display mode to be shorter than the remaining distance at which the display generation unit starts generating the route guidance image in the first display mode.

19. The display control device according to claim 1, further comprising:
a map determination unit that determines whether the high-precision map information can be acquired.

20. The display control device according to claim 1, wherein:
the display generation unit generates the virtual image in the second display mode when the high-precision map information does not include information about a future traveling section of the vehicle.

21. The display control device according to claim 1, wherein:
the display generation unit generates the virtual image in the second display mode in a case where a shape condition to stop generating the virtual image in the first display mode is satisfied with respect to a road shape on which the vehicle travels even when the high-precision map information can be acquired.

22. The display control device according to claim 1, further comprising:
a sensor information acquisition unit that acquires height information of a detected object from an in-vehicle sensor, wherein:
the display generation unit generates the virtual image in a display mode based on a combination of the low-precision map information and the height information when the high-precision map information can not be acquired, and the height information is acquired by the sensor information acquisition unit.

23. The display control device according to claim 1, wherein:
the map information acquisition unit acquires map information including at least one of road gradient information, three-dimensional shape information of a lane marking, and information for estimating a road gradient, as the high-precision map information.

24. A non-transitory computer-readable storage medium which stores program instructions for controlling displaying a virtual image superimposed on a foreground scenery of an occupant of a vehicle,
the program instructions configured to cause one or more processors to:
acquire a position of the vehicle;
acquire high-precision map information or low-precision map information with lower accuracy than the high-precision map information, corresponding to the position;
generate the virtual image in a first display mode based on the high-precision map information when the high-precision map information can be acquired;
generate the virtual image in a second display mode different from the first display mode based on the low-precision map information when the high-precision map information cannot be acquired; and
display the virtual image in the second display mode in a smaller region of a projection area of the virtual image than the first display mode.

25. A non-transitory computer-readable storage medium which stores program instructions for controlling displaying a virtual image superimposed on a foreground scenery of an occupant of a vehicle,
the program instructions configured to cause one or more processors to:
acquire a position of the vehicle;
acquire high-precision map information or low-precision map information with lower accuracy than the high-precision map information, corresponding to the position;
generate the virtual image to be superimposed on a road surface as a specific superimposing target in a first display mode based on the high-precision map information when the high-precision map information can be acquired;
generate the virtual image to be superimposed on the road surface as the specific superimposing target in a second display mode different from the first display mode based on the low-precision map information when the high-precision map information cannot be acquired; and
superimpose and display the virtual image at a superimposing position of the road surface in the first display mode different from the second display mode.

26. A non-transitory computer-readable storage medium which stores program instructions for controlling displaying a virtual image superimposed on a foreground scenery of an occupant of a vehicle,
the program instructions configured to cause one or more processors to:
acquire a position of the vehicle;
acquire high-precision map information or low-precision map information with lower accuracy than the high-precision map information, corresponding to the position;
generate the virtual image to be superimposed on a road surface as a specific superimposing target in a first display mode based on the high-precision map information when the high-precision map information can be acquired;
generate the virtual image to be superimposed on the road surface as the specific superimposing target in a second display mode different from the first display mode based on the low-precision map information when the high-precision map information cannot be acquired; and
present to the occupant whether the virtual image is generated in the first display mode or the second display mode.

27. The display control device according to claim 1, further comprising:
one or more processors; and
a memory coupled to the one or more processors and storing program instructions that when executed by the one or more processors cause the one or more processors to provide at least: the vehicle position acquisition unit; the map information acquisition unit; and the display generation unit.

28. The display control device according to claim 10, further comprising:
one or more processors; and
a memory coupled to the one or more processors and storing program instructions that when executed by the one or more processors cause the one or more processors to provide at least: the vehicle position acquisition unit; the map information acquisition unit; and the display generation unit.

29. The display control device according to claim 15, further comprising:
one or more processors; and
a memory coupled to the one or more processors and storing program instructions that when executed by the one or more processors cause the one or more processors to provide at least: the vehicle position acquisition unit; the map information acquisition unit; and the display generation unit.
